(19) United States
(12) Patent Application Publication
(10) Pub. No.: US 2009/0146415 A1
(43) Pub. Date: Jun. 11, 2009

(54) Pipe-joint structure for heat exchanger

(75) Inventors: Jun Abei, Obu-city (JP); Yoshiki Katoh, Chita-gun (JP); Norimasa Baba, Toyoake-city (JP); Takayuki Hirose, Inazawa-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/315,238

(22) Filed: Dec. 1, 2008

(30) Foreign Application Priority Data
Dec. 10, 2007 (JP) 2007-318773

(51) Int. Cl. F16L 55/00

(52) U.S. Cl. 285/30

(57) ABSTRACT

A pipe-joint structure according to the present invention is advantageously used in an air-conditioner system mounted on an automotive vehicle. A compressor including an expansion valve is connected to an evaporator through the pipe-joint structure. The pipe-joint structure includes an inserting portion of a pipe connected to the compressor and a socket connected to the evaporator. The inserting portion is inserted into a hole formed in the socket. A front end of the inserting portion is positioned not to extend into an enlarged portion of the socket to thereby avoid formation of a dead-end small space between the inserting portion of the pipe and the enlarged portion of the socket. Refrigerant entering the socket from the evaporator smoothly flows without stagnation, and thereby noises caused by the refrigerant flow are suppressed.

### CROSS-REFERENCE TO RELATED APPLICATION

This application is based upon and claims benefit of priority of Japanese Patent Application No. 2007-318773 filed on Dec. 10, 2007, the content of which is incorporated herein by reference.

### BACKGROUND OF THE INVENTION

1. Field of the Invention

The present invention relates to a pipe-joint structure for a heat exchanger. The pipe-joint structure is advantageously applied to piping of a refrigerant cycle for an automotive vehicle.

2. Description of Related Art

An example of a pipe-joint structure in piping a heat exchanger system is disclosed in JP-A-2007-247891. An essence of this pipe-joint structure is shown in FIG. 7 attached hereto. A pair of pipes 210 is connected to a socket 220 that is connected to a heat exchanger. The pair of pipes 210 is coupled by a connecting plate 240. Each pipe 210 includes an inserting portion 211 inserted into the socket 220 and a bulge 212 formed at a foot portion of the inserting portion 211. The socket 220 includes a first inner periphery 221 holding the connecting plate 240 and the bulge 212 therein, a second inner periphery 222 contacting an O-ring 230 and a third inner periphery 223 receiving the inserting portion 211. The socket 220 further includes an inner periphery 224 formed at a foot portion of the socket 220.

The foot portion of the socket 220 is connected to a heat exchanger such as an evaporator. Refrigerant in the heat exchanger flows into the pipe 210 through the socket 220 that connects the heat exchanger to the pair of pipes 210. In the pipe-joint structure shown in JP-A-2007-247891, a space 250 (or a gap) is formed between the inserting portion 211 and the inner periphery 224 because the inserting portion 211 extends beyond an end of the third inner periphery 223. Refrigerant flowing in the direction A shown by an arrow into the inserting portion 211 of the pipe 210 enters into the space 250 and stagnates therein. This stagnation of the refrigerant generates noises in high frequencies.

### SUMMARY OF THE INVENTION

The present invention has been made in view of the above-mentioned problem, and an object of the present invention is to provide an improved pipe-joint structure for a heat exchanger, in which noises generated by flowing refrigerant are suppressed.

The pipe-joint structure according to the present invention may be used in piping a heat exchanger for an air-conditioner mounted on an automotive vehicle. An inlet passage and an outlet passage for circulating refrigerant in an evaporator are connected to an inlet pipe and an outlet pipe of a compressor for compressing the refrigerant through the pipe-joint structure. The refrigerant is vaporized in the evaporator by exchanging heat between outside air and the refrigerant. The refrigerant is returned to the compressor, and the refrigerant compressed in the compressor is again supplied to the evaporator through an expansion valve.

The pipe-joint structure is composed of the inlet and outlet pipes, the inlet and outlet passages of the evaporator and a socket connecting the inlet and outlet pipes to the inlet and outlet passages. Each of the inlet and outlet pipes includes an inserting portion to be coupled to the socket which is connected to the inlet and outlet passages of the evaporator. The socket includes an inlet hole and an outlet hole, each hole having an inner periphery (a third inner periphery in the detailed description of the invention) contacting the inserting portion and an enlarged inner periphery (a fourth inner periphery in the detailed description of the invention). The enlarged inner periphery has a diameter which is larger than the inner periphery.

The front end of the inserting portion of the pipe is positioned not to extend into a space formed by the enlarged inner periphery, so that a dead-end small space is not formed between the outer periphery of the inserting portion and the enlarged inner periphery. The refrigerant flowing from the evaporator toward the socket flows smoothly without stagnation because no dead-end small space is formed in the socket. If the dead-end small space exists, the refrigerant stagnates there and generates noises when the refrigerant passes through the socket.

The position of the front end of the inserting portion may be controlled not to form the dead-end small space only in the outlet hole through which the refrigerant flows from the evaporator to the outlet pipe. In this manner, the passing noise of the refrigerant can be prevented. The present invention may be also applied to a pipe-joint connecting a single pipe in which flow directions are switched.

According to the present invention, noises of the refrigerant that are generated when the refrigerant passes through the pipe-joint are prevented by properly positioning the front end of the pipe in the socket. Other objects and features of the present invention will become more readily apparent from a better understanding of the preferred embodiments described below with reference to the following drawings.

### BRIEF DESCRIPTION OF THE DRAWINGS

FIG. 1 is a front view showing an evaporator used in a refrigerant cycle of an air-conditioner mounted on an automotive vehicle;

FIG. 2 is a side view of the evaporator viewed in direction II shown in FIG. 1;

FIG. 3 is a cross-sectional view (partially a plan view) showing a pipe-joint structure according to the present invention;

FIG. 4 is a cross-sectional view showing a pipe-joint structure as a first embodiment of the present invention;

FIG. 5 is a cross-sectional view showing a pipe-joint structure as a second embodiment of the present invention;

FIG. 6 is a cross-sectional view showing a pipe-joint structure as a third embodiment of the present invention; and

FIG. 7 is a cross-sectional view showing a conventional pipe-joint structure.

### DETAILED DESCRIPTION OF THE PREFERRED EMBODIMENTS

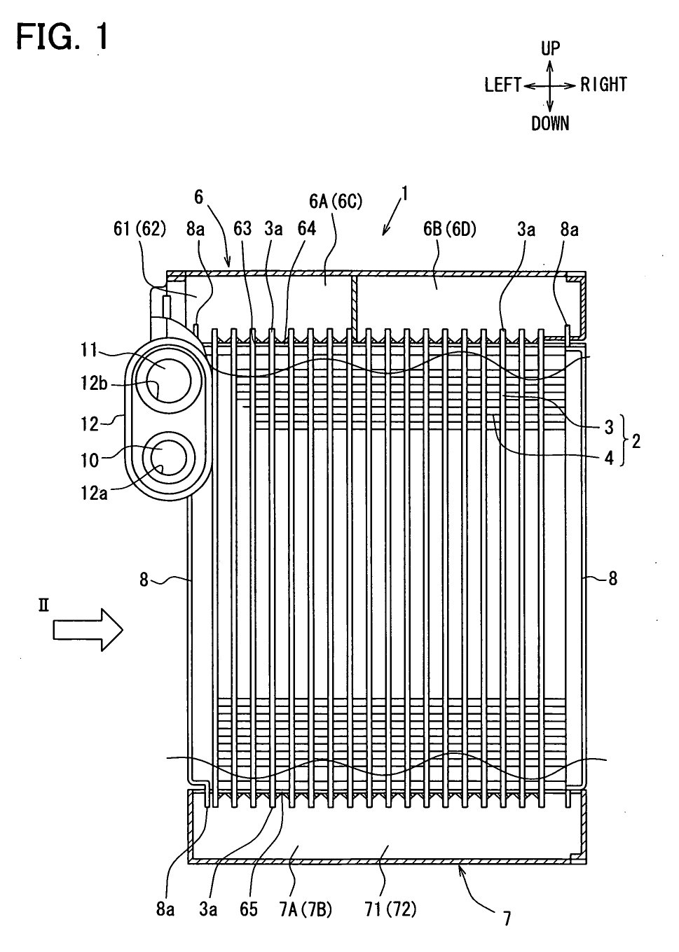

A first embodiment of the present invention will be described with reference to FIGS. 1-4. A pipe-joint structure as a first embodiment according to the present invention is applied to a junction between an evaporator 1 and another device such as a compressor (not shown) in an air-conditioner mounted on an automotive vehicle.

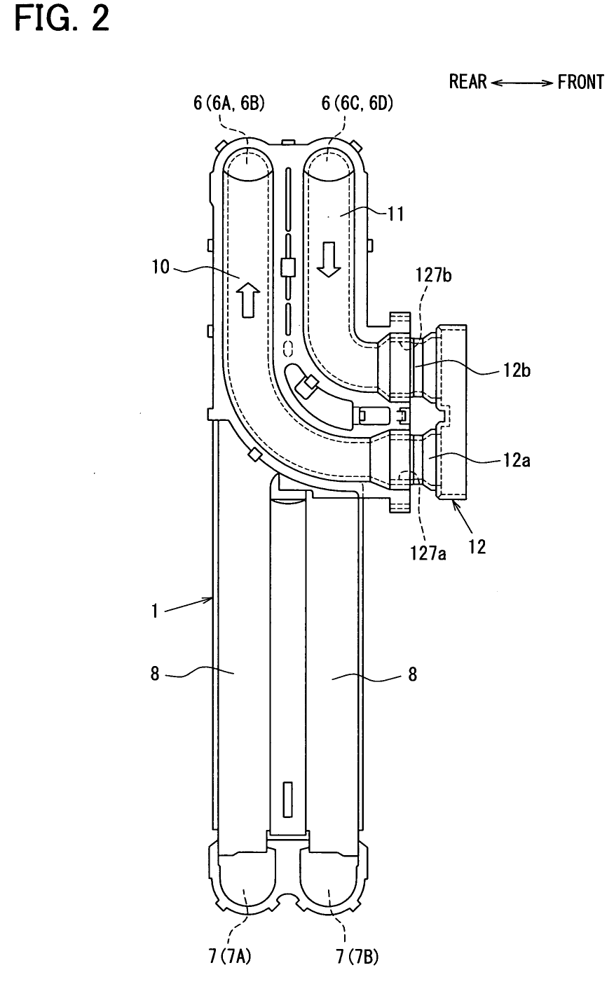

As shown in FIG. 1, the evaporator 1 is composed of a core 2, an upper tank 6, a lower tank 7 and a pair of side plates 8. The core 2 is composed of plural tubes 3 and plural fins 4. The core 2 is supported by the side plates 8 at both sides. An inlet 61 of the upper tank 6 is connected to a refrigerant inlet passage 10, and an outlet 62 of the upper tank is connected to a refrigerant outlet passage 11. Open ends of the refrigerant inlet and outlet passages 10, 11 are connected to a socket 12. The cores 2, upper tanks 6 and lower tanks 7 are disposed in two rows in a front-to-rear direction as shown in FIG. 2. Heat is exchanged between the refrigerant flowing through the evaporator 1 and air blown in the front-to-rear direction by a blower, and cooled air is supplied to a passenger compartment.

In the upper tank 6, the inlet 61 is disposed at a left end of a rear tank, and the outlet 62 is disposed at a left end of a front tank. The upper tank 6 is composed of an upper-left-rear tank 6A connected to the inlet 61, an upper-right-rear tank 6B disposed at a right side of the upper-left-rear tank 6A, an upper-left-front tank 6C connected to the outlet 62 and an upper-right-front tank 6D disposed at a right side of the upper-left-front tank 6C. The lower tank 7 is composed of a lower-rear tank 7A and a lower-front tank 7B. The lower tanks 7A, 7B are connected to the upper tank 6 through the plural tubes 3.

Each tube 3 forming the core 2 together with the fins 4 is formed in a flat shape and has an inner fin for improving heat exchange efficiency. The plural tubes 3 are grouped into four groups because the upper tank 6 is composed of four tanks and the lower tank 7 is composed of two tanks as described above. The refrigerant communicates between the upper tank 6 and the lower tank 7 through the four groups of the tubes 3. More particularly, the refrigerant supplied to the upper-left-rear tank 6A from the inlet 61 is circulated via the tubes 3 through the following order: the lower-rear tank 7A→the upper-right-rear tank 6B→the upper-right-front tank 6D→the lower-front tank 7B→the upper-left-front tank 6C. Then, the refrigerant flows out of the evaporator 1 from the upper-left-front tank 6C through the outlet 62.

The tubes 3, the upper tank 6 and the lower tank 7 are formed separately from one another, and these are connected into a unitary body of the evaporator 1 by brazing. More particularly, the tubes 3 are inserted into holes 63 formed in a lower wall 64 of the upper tank 6, and portions 3a of the tubes 3 projected from the lower wall 64 are connected to the lower wall 64 by brazing. The projected portions 3a projected from an upper wall 65 of the lower tank 7 are connected to the upper wall 65 in the same manner. The side plates 8 are disposed at both sides of the core 2. Upper and lower ends of each side plate 8 are bent in an L-shape and extend into insides of the upper tank 6 and the lower tank 7. The extended portions of the side plates 8 are connected to the upper tank 6 and the lower tank 7 by brazing.

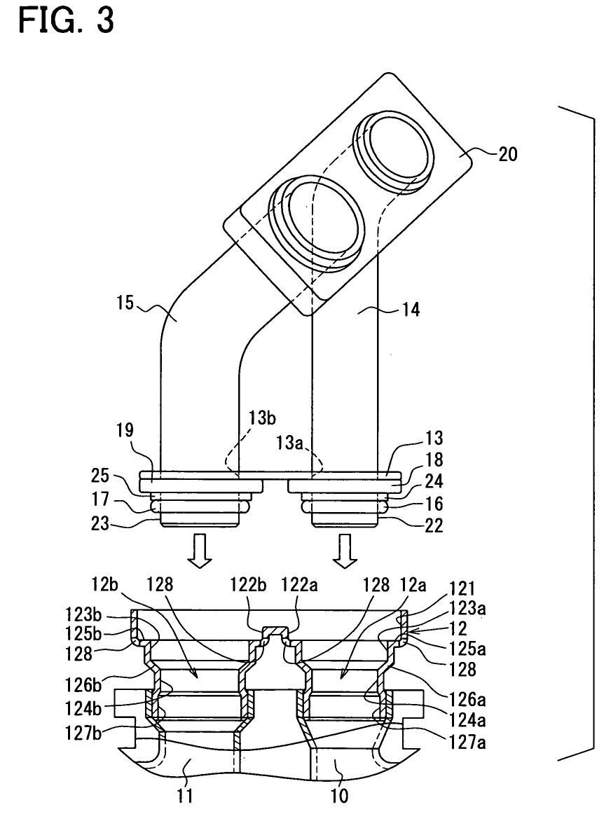

As shown in FIG. 2, the refrigerant inlet passage 10 and the refrigerant outlet passage 11 are connected to the upper-left-rear tank 6A and to the upper-left-front tank 6C, respectively. Both passages 10, 11 extend in a direction parallel to the tubes 3 and bent frontward at a substantially right angle. A socket 12 is connected to open ends of the passages 10, 11. More particularly, the inlet passage 10 is connected to an outside portion forming a fourth inner periphery 127a of the socket 12 by brazing. Similarly, the outlet passage 11 is connected to an outside portion forming a fourth inner periphery 127b of the socket 12 by brazing. As shown in FIG. 3, two pipes 14, 15 are coupled to the socket 12 connected to the refrigerant passages 10, 11 by staking, thereby connecting the two tubes 14, 15 to the refrigerant passages 10, 11, respectively.

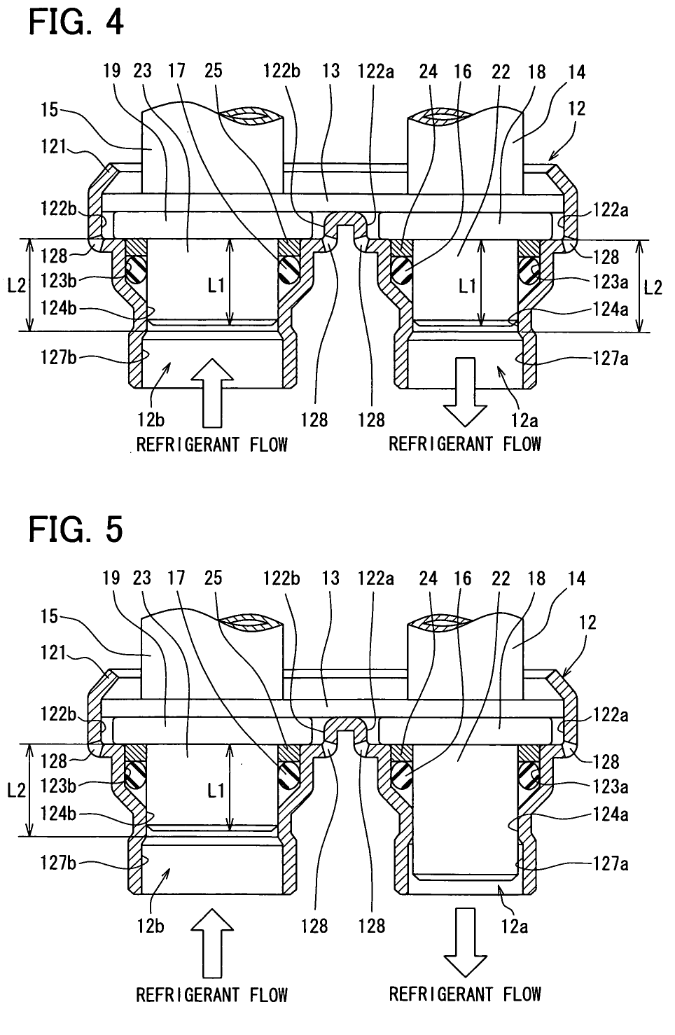

Now, referring to FIGS. 3 and 4, a pipe-joint structure according to the present invention will be described. An inlet pipe 14 and an outlet pipe 15 are connected to each other at one end by a connecting plate 13 and at the other end by a plate 20. Both pipes 14, 15 are inserted into through holes 13a, 13b of the connecting plate 13 at one end while connected to the plate 20 by brazing at the other end. The other ends of the pipes 14, 15 connected to the plate 20 are adapted to be easily coupled to outside pipes.

The inlet pipe 14 is a pipe having an outer diameter, e.g., ½ inch for supplying refrigerant de-pressurized by an expansion valve attached to a compressor. The outlet pipe 15 is a pipe having an outer diameter, e.g., ⅝ inch for returning the refrigerant from the evaporator 1 to the refrigerant compressor. Both of the inlet pipe and the outlet pipe are made of aluminum.

Inserting portions 22, 23 are formed at the one end of the pipes 14, 15. Bulges 24, 25 are formed on the inserting portions 22, 23, as shown in FIG. 3. Washers 24, 25 made of a sacrifice-corrosive material are disposed in contact with the connecting plate 13. O-rings 16, 17 (sealing rings) are disposed next to the washers 24, 25, respectively. In other words, the washers 24, 25 are positioned between the bulges 18, 19 and the O-rings 16, 17, respectively. The washers 24, 25 serve as parts for preventing corrosion of sealing surfaces of second inner peripheries 123a, 123b contacting the O-rings. The washers 24, 25 are made of a material that is corroded more easily than a material forming the second inner periphery 123a, 123b.

The connecting plate 13 is made of aluminum or an aluminum alloy and is formed in an oval shape, and has through-holes 13a, 13b, each of which are a little larger than an outer diameter of the pipes 14, 15. After inserting the tubes 14, 15 into the through-holes 13a, 13b, the pipes 14, 15 are enlarged to thereby connect the pipes 14, 15 to the connecting plate 13.

The socket 12 made of aluminum or an aluminum alloy is formed by a press-work such as drawing. The socket 12 has an inlet hole 12a for inserting the inlet pipe 14 and an outlet hole 12b for inserting the outlet pipe 15. The connecting portion 121 of the socket 12 is formed to correspond to the oral outer periphery of the connecting plate 13. Front surfaces of the bulges 18, 19 contact a bottom surface of the connecting portion 121, and the connecting portion 121 is bent to enclose the connecting plate 13 therein (refer to FIG. 4). In this manner, the inlet pipe 14 and the outlet pipe 15 are connected to the socket 12. The connecting portion 121 forms a first inner periphery 122a, 122b (shown in FIG. 4) when it is bent to hold the connecting plate 13.

As shown in FIGS. 3 and 4, the inlet hole 12a and the outlet hole 12b respectively include a first inner periphery 122a, 122b, a second inner periphery 123a, 123b, a third inner periphery 124a, 124b, all being made coaxially. The first inner periphery 122a, 122b and the second inner periphery 123a, 123b are connected by a first connecting portion 125a, 125b, and the second inner periphery 123a, 123b and the third inner periphery 124a, 124b are connected by a second connecting portion 126a, 126b.

The first connecting portion 125a, 125b contacts the bulge 18, 19. The second inner periphery 123a, 123b is formed to closely contact the outer periphery of the washer 24, 25 and the O-ring 16, 17. In other words, the second inner periphery 123a, 123b and the O-ring 16, 17 form a sealing surface. The third inner periphery 124a, 124b is formed so that the inserting portion 22, 23 of the pipes 14, 15 is easily inserted and closely contact an outer diameter of the inserting portion 22, 23.

A fourth inner periphery 127a, 127b, each having a diameter larger than that of the third inner periphery 124a, 124b, is formed next to the third inner periphery 124a, 124b. The fourth inner periphery 127a, 127b, an outer diameter of which is connected to the refrigerant inlet passage 10 and the refrigerant outlet passage 11, respectively, is formed larger than that of the third inner periphery 124a, 124b to provide it with a higher strength. A drain hole 128 is formed at a junction of the first inner periphery 122a, 122b and the first connecting portion 125a, 125b to drain water retained at the junction. Water condensed in the inlet pipe 14 and the outlet pipe 15 tends to stay at the junction. The condensed water is prevented from being retained at the sealing surface between the O-ring 16, 17 and the second inner periphery 123a, 123b, because the water is drained through the drain hole 128. Condensed water in the evaporator 1 may enter into the socket 12 and may freeze therein. The socket 12 may be broken by expansion of a volume of the frozen water if there is no way for the condensed water to escape. The drain hole 128 also functions to drain the condensed water in the evaporator 1.

As shown in FIG. 4, a front end of the inserting portion 22, 23 is positioned not to extend into the fourth inner periphery 127a, 127b beyond the third inner periphery 124a, 124b when the inserting portion 22, 23 is inserted into the third inner periphery 124a, 124b. More particularly, a length L1 from a front end of the bulge 18, 19 to a front end of the inserting portion 22, 23 is made not to exceed a length L2 from the front end of the bulge 18, 19 to the rear end of the third inner periphery 124a, 124b. That is, the lengths L1 and L2 are made to satisfy the formula: L1≦L2.

A process of forming the pipe-joint structure described above will be briefly explained. The socket 12 is connected to the front end of the refrigerant inlet and outlet passages 10, 11 by brazing at the same time when components of the evaporator 1 are connected by brazing in a brazing oven. Separately from the socket 12, the front portions of the inlet pipe 14 and the outlet pipe 15 jointed together with the plate 20 are inserted into the through-holes 13a, 13b formed in the connecting plate 13. Then, the pipes 14, 15 are connected to the connecting plate 13 by enlarging the diameter of the pipes 14, 15. Then, bulge 18, 19 is formed by a bulge-forming process next to the connecting plate 13, so that the connecting plate 13 closely contacts the bulge 18, 19. The bulge 18, 19 is formed to make the length L1 not to exceed the length L2. Then, the washer 24, 25 and the O-ring 16, 17 are inserted into the outer periphery of the inserting portion 22, 23.

Then, the inserting portions 22, 23 are inserted into the inlet hole 12a and the outlet hole 12b formed in the socket 12, respectively, as shown in FIG. 3. The inserting portion 22, 23 closely contacts the third inner periphery 124a, 124b, as shown in FIG. 4. Then, the connecting portion 121 is bent or rolled inwardly to encompass and hold the connecting plate 13 and the bulge 18, 19 therein. Thus, the pair of tubes 14, 15 are firmly connected to the socket 12 that is connected to the evaporator 1. The connecting plate 13 is firmly connected to the socket 12 by staking the connecting portion 121 around the entire periphery of the connecting plate 13.

Refrigerant, which is in a state of vapor-liquid mixture, expanded through an expansion valve (not shown) is supplied to the evaporator 1 through the inlet pipe 14, the socket 12 and the inlet passage 10. The mixture refrigerant supplied to the evaporator 1 is evaporated by heat exchange between outside air and the refrigerant. The evaporated vapor refrigerant flows out of the evaporator 1 through the outlet passage 11, the socket 12 and the outlet pipe 15.

Flow directions of the refrigerant through the fourth inner peripheries 127a connected to the inlet passage 10 and 127b connected to the outlet passage 11 are different from each other. That is, the refrigerant flows from the socket 12 toward the evaporator 1 in the fourth inner periphery 127a, while the refrigerant flows from the evaporator 1 toward the socket 12 in the fourth inner periphery 127b. The length L1 from the front end of the bulge 18, 19 to the front end of the inserting portion 22, 23 is made not to exceed the length L2 from the front end of the bulge 18, 19 to the rear end of the third inner periphery 124a, 124b, as described above. This means that the front end of the inserting portion 22, 23 does not extend to the space inside the fourth inner periphery 127a, 127b.

If the front end of the inserting portion 23 extends beyond the rear end of the third inner periphery 124b, a dead-end small space is formed between the fourth inner periphery 127b and the inserting portion 23. Since the refrigerant flows from the outlet passage 11 toward the socket 12 in the outlet hole 12b, the refrigerant stagnates in the small space. Noises may be generated when the refrigerant flows through the socket 12 due to the stagnation in the dead-end small space. The length L1 is made not to exceed the length L2 to prevent formation of the dead-end small space. This relation of L1 and L2 is satisfied in both the inlet hole 12a and the outlet hole 12b in the first embodiment though this is necessary only in the outlet hole 12b. Though the socket 12 is formed by press-work from a metallic plate, it is also possible to form it by die-casting or machining.

A second embodiment of the present invention is shown in FIG. 5. In this embodiment, the lengths L1 and L2 are made to satisfy the relation (L1≦L2) only in the outlet hole 12b. In other words, the inserting portion 23 is made not to extend beyond the rear end of the third inner periphery 124b, but the other inserting portion 22 is made to extend beyond the rear end of the third inner periphery 124a. Other structures are the same as those of the first embodiment.

Since the inserting portion 23 is made not to extend in the inner space of the fourth inner periphery 127b, the dead-end small space is not formed between the inserting portion 23 and the fourth inner periphery 127b. Therefore, stagnation of the refrigerant in the outlet hole 12b is prevented, and the refrigerant flow noise due to the stagnation is suppressed.

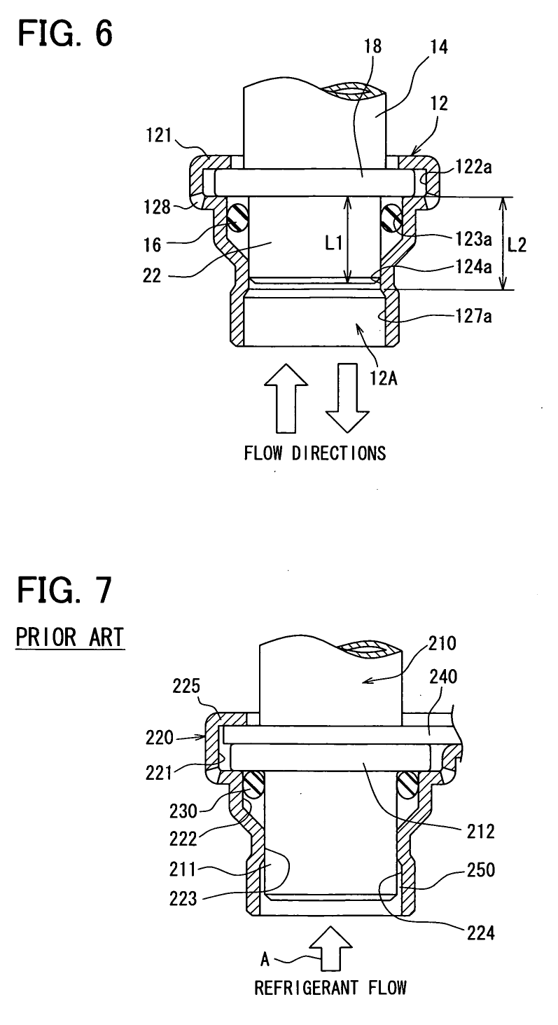

A third embodiment of the present invention is shown in FIG. 6. In this embodiment, the socket 12 has only one port 12A that functions as the inlet hole 12a when the socket 12 is used in such a flow direction and functions as the outlet hole 12b when the socket 12 is used in such a flow direction. In this embodiment, no connecting plate 13 is used because there is only one port 12A. The washer 24, 25 are not used in this embodiment. A connecting portion 121 of the socket 12 is bent inwardly to hold the bulge 18 therein. Other structures and functions are the same as those of the first embodiment. The lengths L1 and L2 are made to satisfy the relation (L1≦L2) in this embodiment, too. Therefore, no dead-end small space is formed between the inserting portion 22 and the fourth inner periphery 127a, and stagnation of the refrigerant is prevented even when the refrigerant flows in the direction from the evaporator 1 toward the socket 12. Accordingly, noises of the refrigerant flow due to the stagnation are prevented.

The present invention is not limited to the embodiments described above, but it may be variously modified. For example, the size of the inletpipe 14 and the outlet pipe 15 may be variously changed though the inlet pipe 14 having a ½ inch outer diameter and the outlet pipe 15 having ⅝ inch outer diameter are used in the first and the second embodiments. Though the pipe-joint structure of the present invention is applied to a joint connecting an evaporator 1 and another device in the foregoing embodiments, it may be applied to other joints connecting one or two fluid passages.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A pipe-joint structure for a heat exchanger, the pipe-joint structure comprising:
a pipe having a cylindrical inserting portion at its open end and a bulge formed on a foot portion of the inserting portion;
an O-ring disposed around an outer periphery of the inserting portion;
a cylindrical socket having a rear end connected to a fluid passage of the heat exchanger and a front end coupled to the pipe, the socket including a first inner periphery for receiving the bulge, a second inner periphery contacting the O-ring and a third inner periphery receiving the inserting portion, the first, second and third inner peripheries being positioned in this order from the front end toward the rear end of the socket, wherein:
a fourth inner periphery having a diameter larger than that of the third inner periphery is formed at the rear end of the socket; and
the open end of the pipe is positioned not to extend beyond a rear end of the third inner periphery of the socket.

2. The pipe-joint structure as in claim 1, wherein a length (L1) of the inserting portion from its open end to a front end of the bulge is made not to exceed a length (L2) from the rear end of the third inner periphery to the front end of the bulge (L1≦L2).

3. The pipe-joint structure as in claim 1, wherein fluid in the heat exchanger is adapted to flow toward the socket of the pipe-joint structure from the heat exchanger through the fluid passage.

4. A pipe-joint structure for a heat exchanger, the pipe-joint structure comprising:
a pair of pipes each having a cylindrical inserting portion at its open end and a bulge formed on a foot portion of the inserting portion;
an O-ring disposed around an outer periphery of each inserting portion;
a socket having two holes, each hole having a rear end connected to a fluid passage of the heat exchanger and a front end coupled to each pipe, each hole of the socket including a first inner periphery for receiving the bulge, a second inner periphery contacting the O-ring and a third inner periphery receiving the inserting portion, the first, second and third inner peripheries being positioned in this order from the front end of each hole toward the rear end of each hole, wherein:
a fourth inner periphery having a diameter larger than that of the third inner periphery is formed at the rear end of each hole of the socket; and
the open end of each pipe is positioned not to extend beyond a rear end of the third inner periphery of each hole of the socket.

5. The pipe-joint structure as in claim 4, wherein, a length (L1) of the inserting portion of each pipe from its open end to a front end of the bulge is made not to exceed a length (L2) from the rear end of the third inner periphery of each hole to the front end of each bulge (L1≦L2).

6. The pipe-joint structure as in claim 4, wherein, the fluid passage connected to the rear end of each hole is either an inlet or outlet refrigerant passage of the heat exchanger.

7. A pipe-joint structure for a heat exchanger, the pipe-joint structure comprising:
a pair of pipes each having a cylindrical inserting portion at its open end and a bulge formed on a foot portion of the inserting portion;
an O-ring disposed around an outer periphery of each inserting portion;
a socket having two holes, each hole having a rear end connected to a fluid passage of the heat exchanger and a front end coupled to each pipe, each hole of the socket including a first inner periphery for receiving the bulge, a second inner periphery contacting the O-ring and a third inner periphery receiving the inserting portion, the first, second and third inner peripheries being positioned in this order from the front end of each hole toward the rear end of each hole, wherein:
a fourth inner periphery having a diameter larger than that of the third inner periphery is formed at the rear end of each hole of the socket; and
the open end of one of the pair of pipes is positioned not to extend beyond a rear end of the third inner periphery of the hole of the socket to which the one of the pair of pipes is inserted.

8. The pipe-joint structure as in claim 7, wherein fluid flows from the heat exchanger to one of the pair of pipes, the open end of which is positioned not to extend beyond the rear end of the third inner periphery of the hole.

9. The pipe-joint structure as in claim 7, wherein a length (L1) of the inserting portion, open end of which is positioned not to extend beyond the rear end of the third inner periphery of the hole, from the open end to a front end of the bulge is made not to exceed a length (L2) from the rear end of the third inner periphery to the front end of the bulge (L1≦L2).

10. The pipe-joint structure as in claim 7, wherein, the fluid passage connected to the rear end of each hole is either an inlet or outlet refrigerant passage of the heat exchanger.
